(19) United States
(12) Patent Application Publication
(10) Pub. No.: US 2008/0184341 A1
(43) Pub. Date: Jul. 31, 2008

(54) Master-Slave Protocol for Security Devices

(76) Inventors: David Jaroslav Sebesta, Redmond, WA (US); Shon Schmidt, Seattle, WA (US); Zhangwei Xu, Redmond, WA (US); Todd L. Carpenter, Monroe, WA (US); William I. Westerinen, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/668,445

(22) Filed: Jan. 29, 2007

(51) Int. Cl. H04L 9/32

(52) U.S. Cl. 726/4

(57) ABSTRACT

A computer or electronic device uses a dedicated communication protocol for configuring, managing, and end-of-life operation of a master device controlling a plurality of security devices. The protocol includes messages for binding each security device to the master, for installing cryptographic keys, periodic heartbeat signals, as well as shutdown and disable-security messages.

This application is related to co-pending application filed the same day with attorney docket number 30835/318446.

### BACKGROUND

When a business model allows selling a product at little or no cost and recouping the product's cost by selling services, such as with cellular phones, a key element is the ability to render the product useless if the terms of the service contract are not fulfilled. For example, if a cellular phone service subscriber fails to pay the agreed-to monthly fee, the service provider can simply turn off the phone's access to the network. Because the value of the phone is extremely limited if it cannot make phone calls, the service provider's investment is protected. Further, because the cellular phone may have little or no street value, there is little incentive to defraud the service provider for the sole purpose of getting an inexpensive cellular phone.

However, a subsidized computer may have considerable use and value when not connected to a network. Therefore, a business model that supplies computers or other high intrinsic value electronic devices to consumers at a reduced initial cost along with a services contract, e.g. Internet service access, must have a way of limiting access to the computer when the terms of contract are not fulfilled.

### SUMMARY

A computer or electronic device adapted for metered-use may use a master security device and a plurality of slave devices, each of the plurality of slave devices attached to a functional component of the computer or electronic device. Each slave device may be programmed to disable its associated functional component. Management of the slave devices by the master device may use a protocol including messages for firmware updates, periodic ping messages, and a shutdown message when tampering has been detected. A further message, known as a perpetual message, may be used when and end-user has satisfied contractual terms associated with a subsidized purchase to disable all security mechanisms and allow the end-user unrestricted access to the computer or electronic device.

### BRIEF DESCRIPTION OF THE DRAWINGS

FIG. 1 is a simplified and representative block diagram of a prior art computer;

FIG. 2 is a block diagram of a simplified and representative computer in accordance with the current disclosure;

FIG. 3 is a simplified and exemplary block diagram illustrating a functional view of a representative computer in accordance with the current disclosure;

FIG. 4 is a simplified and exemplary block diagram of a security module; [[and]]

FIG. 5 is a flow chart depicting a method of operating a computer in a full or a reduced function mode;

FIG. 5A is a flow chart depicting additional detail of the method of FIG. 5;

FIG. 5B is a flow chart depicting additional detail of the method of FIG. 5;

FIG. 6 is a flow chart depicting a method of performing a firmware update for a slave device;

FIG. 7 is a flow chart depicting a method of operating master and slave devices to detect hardware tampering in an exemplary electronic device;

FIG. 8 is a flow chart depicting a method of sending a shutdown message from a master device to a slave device;

FIG. 9 is a flow chart depicting a method of sending a perpetual message from a master device to a slave device; and

FIG. 10 is a flow chart depicting a method of sending a timer reset message to each slave device in an exemplary electronic device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

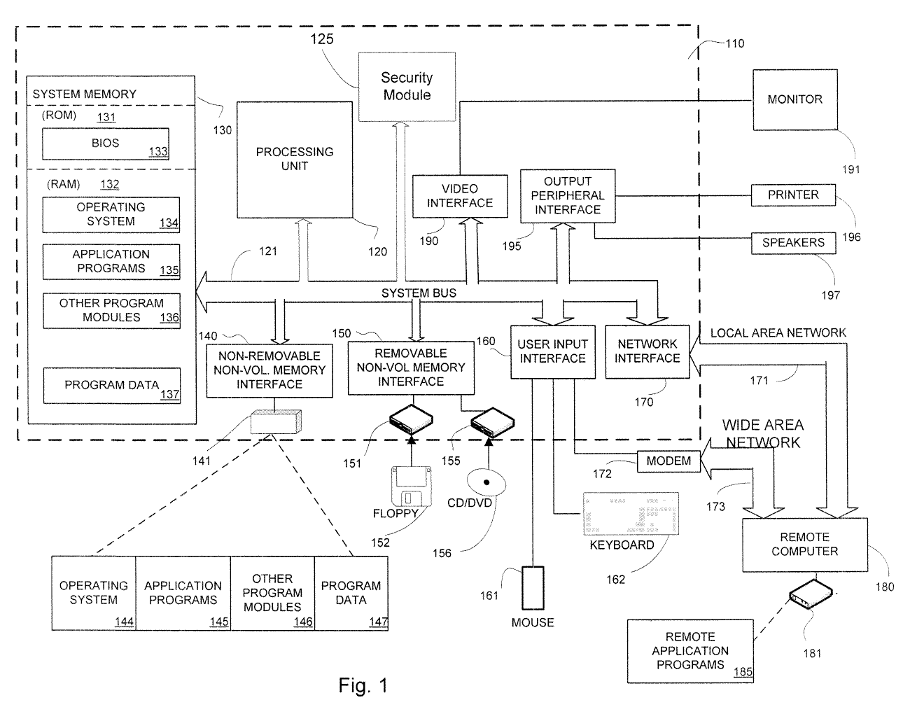

FIG. 1 illustrates a computing device in the form of a computer 110 incorporating a device supporting direct memory access for compliance checking. Components of the computer 110 may include, but are not limited to a processing unit 120, a system memory 130, and a system bus 121 that couples various system components, including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Computer storage media typically embodies computer readable instructions, data structures, program modules or other data.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. In a pay-per-use or subscription application, remote application programs 185 may include initialization and provisioning services.

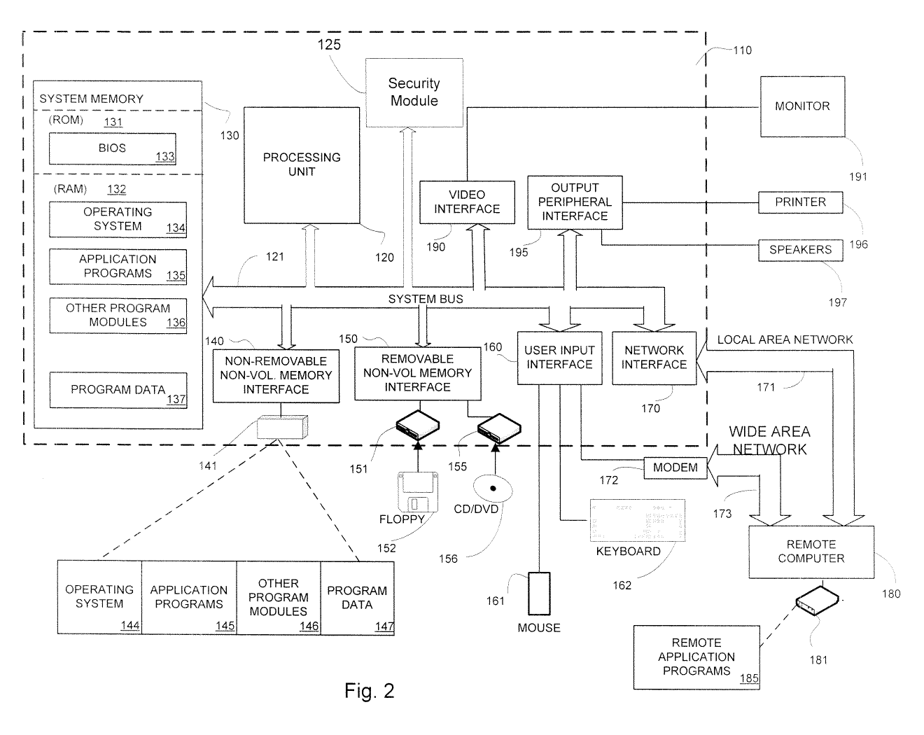

A master security module 125 may be deployed and configured to enforce the terms of an agreement between a user of the computer 110 and a service provider with an interest in the computer 110. The master security module 125 may be instantiated in more than one manner. When implemented by one or more discrete components, master security module 125 may be disposed on the motherboard (not depicted) or in a multi-chip module (MCM) that is, itself, disposed on the motherboard. The master security device 125 and associated security beans (not depicted in FIG. 1) are discussed in more detail below with respect to FIGS. 2-4.

FIG. 2 illustrates a computer 200, or other processor-based device, as listed above, adapted for use with a master-slave security device or devices. The computer 200 may have a processor 202, and two major support chips: a memory/graphics interface 204 and an I/O interface 210, e.g. a Northbridge and a Southbridge. The memory/graphics interface 204 may support a graphics processor 208 and system memory 206. The graphics processor 208 may be coupled to a monitor or other display (not depicted). The I/O interface 210 may support a mouse/keyboard 212 or other input devices. A universal serial bus (USB) 214 may be used to interface external peripherals including flash memory, cameras, network adapters, etc. (not depicted). Nonvolatile memory 216, such as a hard disk drive or any of a number of other non-volatile memories, may also be coupled to the I/O interface 210. A master device 226 may include memory storing one or more BIOS images for use in booting the computer 200. The master device 226 may also include other functions associated with metering and other system verification and enforcement measures. For the purpose of clarity, those aspects of the master device 226 will not be discussed in this disclosure. The master device 226 may have separate communication channels, a first channel 227 may be used to communicate with slave security devices, or “security beans” (SBs). The second channel 228 may be coupled conventionally to the I/O interface 210. Additional communication channels may be supported, for example, a separate communication channel for each configuration of security devices (see below).

The processor 202 and memory/graphics interface 204 may be connected as above, with a front-side bus 218. The memory/graphics interface 204 to I/O interface 210 connection may be a high speed system bus 219. The system bus 219 may be used to generate clock signals for other high speed buses, such as an I/O interface 210 to non-volatile memory 216 interface 220. Other configurations of system components, including alternative bus structures, such as Hypertransport®, may also be used.

A power supply 222 may have a signal output 224 indicating when the power supply is at voltage and stable. As discussed above, the power supply may have one or more outputs (not depicted) coupled to each active system component. For the purpose of this discussion, output 224 will be presumed to be a “power OK” signal, but other signals, including the power bus lines themselves, may be involved. Each component with a power OK input will remain non-operational until the power OK signal input transitions to a designated active state, for example, a logic 1 value.

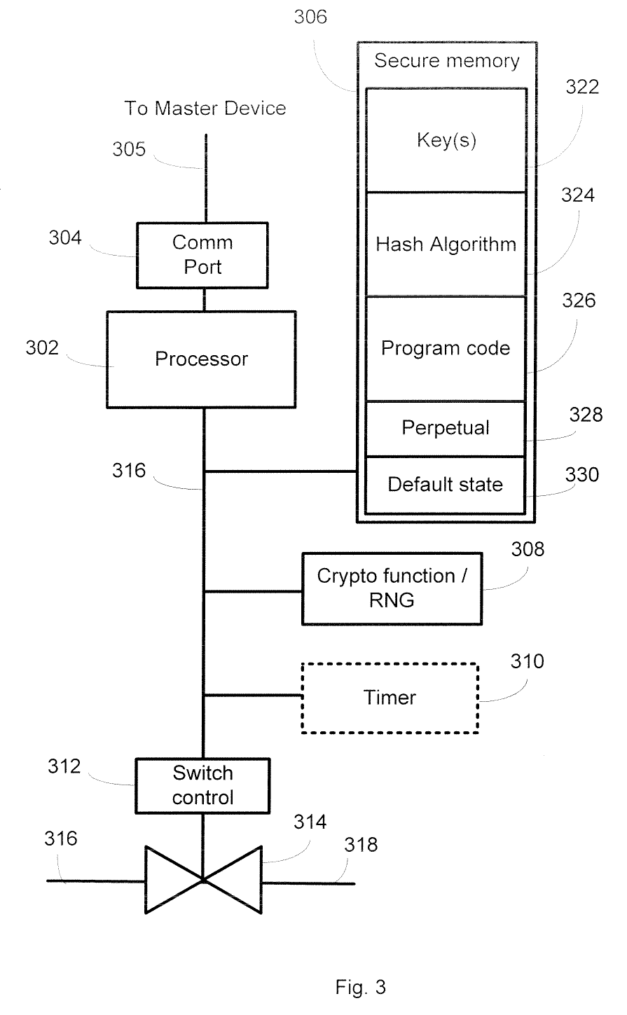

As will be discussed in more detail below with respect to FIG. 3, a security device or a security bean (SB) may operate as an connect/disconnect switch between two points and may be installed in any of several configurations. In a first configuration, one or more security beans 230 may be coupled in a serial fashion to the power OK input of a number of system components, including the memory/graphics interface 204, system memory 206, graphics processor 208, USB port 214, and nonvolatile memory 216. In this configuration, the switching function in the security bean 230 may start in the normally off (disconnected) mode and block the power OK signal 224 from the power supply 222, effectively disabling each connected component. When the master device 226 determines that criteria have been met for operations, the master device 226 may send an activation signal to each of the security beans 230 instructing each one to close its switching function and couple the power OK signal 224 to its respective component, allowing that component to start in a normal fashion.

In another configuration of the slave device, security bean 232 is shown coupled between the mouse/keyboard 212 and the I/O interface 210. As above, the default configuration for the security bean 232 may be with switch function open, blocking any signals between the mouse/keyboard 212 and the I/O interface 210. When the master device 226 determines that criteria have been meant for operations, the master device 226 may send instructions to close the switching function and enable the mouse/keyboard 212. Because the security device authentication process may be completed very early in the boot process, the mouse/keyboard 212 may be active prior to BIOS system checking, so initial blocking should not cause a system error. Alternatively, because in some embodiments the BIOS is hosted in the master device 226 and may be aware of the security bean 232, the BIOS may be able to selectively activate devices during initial system checking when booting.

Another configuration of the slave device is illustrated by security bean 234 and associated load 236, shown in this exemplary embodiment attached to system buses 219 and 220, or more specifically, to a single signal path on each respective bus. In this configuration, the security bean 234 switch function may be normally closed, coupling load 236 to the respective bus 219 or 220. Coupling the load 236 to a bus may alter the transmission characteristics sufficiently to render the bus in operable, for example, if coupled to a clock line. Additional security beans configured in this fashion may be attached to multiple lines of a data bus, thereby disabling each respective data line.

Lastly, security bean 238 is shown unattached. One or more unattached security beans 238 may be placed in an electronic device, and even coupled to signal connections, such as a ground plane, to act as decoys to further raise the bar of disabling active security beans 230 232 234. Depending on the exact design of the security bean, e.g. bean 230, the security bean have a material cost of well less than a dollar, allowing widespread deployment without significant impact on end-user price, while creating a significant cost of hacking in terms of time, tools, and risk of damage to the computer or other protected electronic device. Additional decoys, or dummy devices, may be attached to real components but factory-set to perpetual mode (see below) so that they do not participate in communication between the master device and other security beans. Such devices may also be loaded with dummy keys to obfuscate key extraction efforts. In other embodiments, decoy devices may be in communication with the master device 226 and respond to ping requests, although have no connection to other components in the electronic device.

FIG. 3 is a simplified and exemplary block diagram of a security device, also known as a slave device or a security bean 300. A processor 302 may execute programs and control communications with a master device, such as the master device 226 of FIG. 2. A communications port 304 may manage communication protocol over interface 305, such as a serial peripheral interface (SPI). The security bean 300 may also include a secure memory 306, a cryptographic function 308, an optional timer 310, a switch control 312, and a switch 314 with an input coupling 316 and an output coupling 318.

The processor 302 may be a microprocessor with a standard or reduced instruction set but may also be an application specific integrated circuit (ASIC) implementing simple logic or a state machine. The communication port 300 for may be a dedicated port, may be a separate ASIC circuit implementing a communication protocol in hardware, or may be incorporated in the processor 302.

The secure memory 306 may include both volatile and nonvolatile memory for use in storing persistent data as well as for use by the processor 302 during operation. The secure memory 306 may include keys 322, a hash algorithm 324, and program code 326, as well as a perpetual flag 328 and a default state flag 330. The keys 322 may include a local master key accepted from a master device 226 during configuration with the master device 226. Derived keys, session keys, or local hash values may also be stored in the keys section 322. The hash algorithm 324 may be any of a number of known algorithms, such as MD5 or SHA-256. Program code 326 may be executable instructions that the processor 302 can use during both configuration and normal operation phases. The perpetual state 328 stored at in the secure memory 306 may be a simple flag used to indicate whether the security bean 300 should be permanently placed in a normal operating state or a so-called perpetual state. The perpetual state may be used to turn off all security functions in a computer. This may include setting the security bean 300 so that the computer can operate without any restrictions, for example, after a subscriber has successfully met contractual terms for a subsidized purchase and takes full ownership of the computer or electronic device. The default state 330 may be set to determine whether the default value (i.e. the state of the switch 314 required to disable its associated component) for switch control 312 is open or closed, depending upon the use of the security bean 300 in a circuit.

The cryptographic function 308 may include a hash function for use instead of or in conjunction with a hash algorithm 324 stored in the secure memory 306. The cryptographic function 308 may also include a random number generator (RNG) for use in challenge/response communication with the master device 226. The cryptographic function 308 may include general encryption/decryption functions which may be used, in part, for generating and verifying a message authentication code (MAC).

The optional timer 310 may be used as described below when the security bean 300 operates to disable its respective circuit unless reset during a timeout period, set by the timer 310.

The switch control 312 may be simple logic to convert a command from the processor 302 to control and persist the state of switch 314. Switch 314 may be an ordinary analog switch, known in the art. Even though signal lines 316 and 318 have been designated as an input coupling and output coupling respectively, in one embodiment, the signal lines 316 318 are interchangeable.

During initial setup, a key may be accepted from the first party who presents a valid format key. Ideally, this operation would take place in a secure environment since the security bean 300 may not have a transport key for encrypting the communication link 305 during initial set up. The key may be derived key based on a security bean serial number and a master key installed in the master device 226. Additionally, the default state 330 may be set during initial setup so that the switch 314 is either normally on or normally off upon power up. The key memory 322 and default state flag 330 may be a write-once memory, such as a fusable link or other one-time programmable technology. In some embodiments, the perpetual flag 328 may also be a one-time programmable memory.

After installation and upon startup the security bean 300, the switch 314 may be set to the default state and the security bean 300 may wait for communication from the master device 226. Using a normal challenge/response, the master device 226 and the security bean 300 may mutually authenticate each other. The master device 226 can send a signal that sets the security bean 300 to enable its associated component, be it a power OK signal 230, a signal path 232, or a bus load 234. A dummy device 236 may be powered and may also be in communication with the master device 226, in order to further obfuscate the active devices.

As described below, several alternatives exist for security bean 300 operation, including but not limited to timeout, ping response, and a combination of the two. In timeout operation, the bean 300 begins a timeout period as soon as switch 314 is set to the enabled mode after power up. After a predetermined time the timer 310 may expire, for example, in one minute, and the switch 314 transitioned to disable its respective component. The timeout timer 310 may be reset by an authenticated signal from the master device 226. In another embodiment, the bean 300 may start in the enabled mode and begin its timing cycle without communication from the master device 226. The switch 314 may be set to disabled mode unless the timer is reset by the authenticated signal from the master device 226 during the timeout period.

In the ping response mode, the security bean 300 may start in the disabled mode and wait for an authenticated signal to switch to the enabled mode. Subsequently, the master device 226 may ping the security bean 300, to which the security bean 300 may reply. After collecting ping response data from all the security devices 300 installed and configured, the master device 226 may determine that enough beans 300 have not responded and a tampering problem may exist. At that point, the master device 226 may send a disable signal to all responsive security beans 300, causing them to switch to disabled mode. In some embodiments, the disable bit 330 may be set by the disable signal, so that during the next power cycle or reset cycle, the security bean 300 may stay in the disabled mode until explicitly turned off by the master device 226. This may be useful if the security bean 300 is configured to boot into an enabled mode.

The security bean 300 may store more than one version of key, so that a challenge/response transaction may include a key version for use in creating the appropriate session key. The security bean 300 may also store an encryption key and a signing key, when required by a particular protocol.

When contract terms have been satisfied, a host server (not depicted) or other trusted device, may send a signal to the master device 226 that the computer 200 should go perpetual, indicating that all security measures should be de-activated. In one embodiment, when the perpetual bit 328 is set, the security bean 300 may always boot to the enabled state, ignore the timer if present, and ignore messages from the master device 226. In another embodiment, the perpetual flag 330 may be reset, for example, when a computer is traded in for an upgrade and recycled.

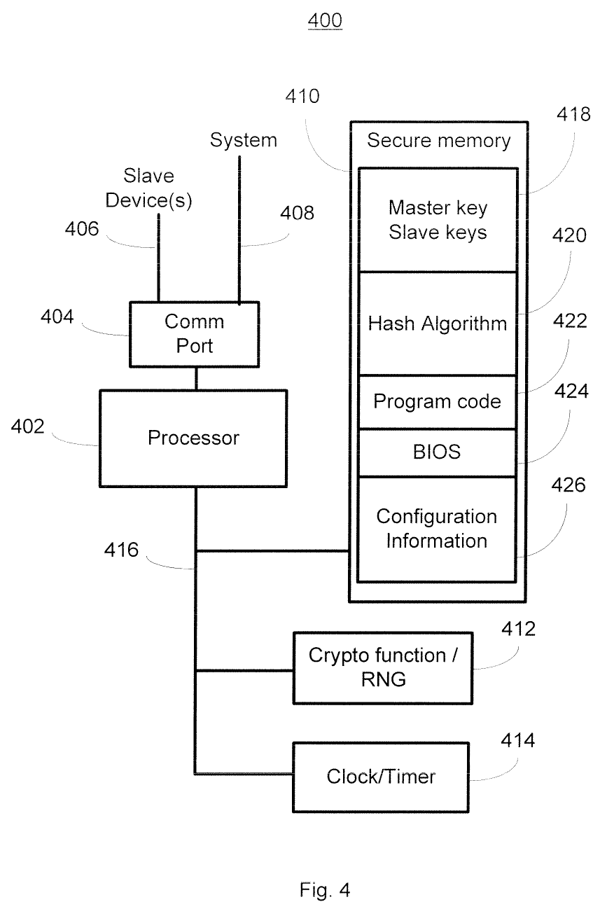

FIG. 4, a simplified and representative block diagram of a master device 400, the same as or similar to the master device 226 of FIG. 3, is discussed and described. The master device 400 may include a processor 402, a communication port 404, a secure memory 410, the cryptographic function 412 and a clock or timer 414. The processor 402 may be a core processor implemented in a custom or so accustomed design, or may be part of a single-chip computer, or may be one component in a multi-chip module (MCM). Communication port 404 may support more than one communication protocol, for example as depicted in FIG. 4, connection 406 supports communication with slave devices, such as slave device 300 of FIG. 3, using, for example, an SPI protocol. The communication port 404 may also support a conventional system bus interface to other components of a system incorporating the master device 400, such as the system 200 of FIG. 2.

The secure memory 410 may include key memory 418 storing a device master key and slave keys generated for each slave associated with the master device 400. A hash algorithm 420 may be stored in the secure memory 410 for use one hashing is calculated by the processor 402. Program code 422 may include executable code for managing the operation of the master device 400. In implementations where the master device 400 manages BIOS code, such BIOS code 424 may be stored in a secure memory 410. A secure boot, or at least a boot cycle using known BIOS code, may be necessary to ensure that the master device 400 and its associated security beans 300 are operational and enabled before boot processes associated with initially deactivated components begin. Configuration information 426 may be used to store information regarding known security beans, their mode of operation, and if perpetual mode is active.

The cryptographic function 412 may be as simple as a random number generator and a block cipher function, or may incorporate a smart chip with full cryptographic capability including public key algorithms, and communicate with the processor 402 using an ISO 7816 interface.

A clock or timer 414 may be used to determine timeout periods during which security beans 300 must respond to a ping. When the master device 400 also incorporates metering functions associated with pay-per-use operation, the clock or timer 414 may be directed to that purpose also.

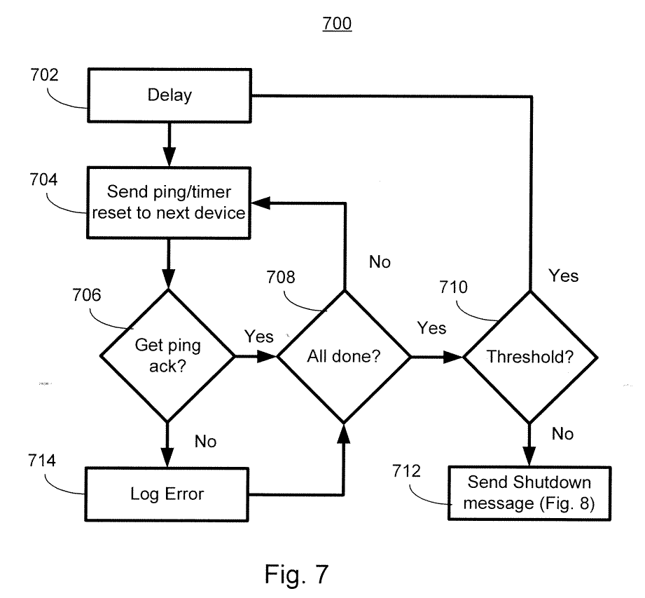

In operation, the master device 400 may operate in one of several modes. In one embodiment, after cataloging and sending a derived key to each security bean 300, the master device 400 may periodically send an encrypted, or MAC'd, reset signal to each security bean 300. Upon verification of the reset signal, the bean may reset its timeout timer and normal operation is preserved. In another embodiment, the master device 400 may periodically ping each catalogued security bean 300. If enough security beans 300 do not respond in a timely fashion, the master device 400 may send a disable signal to each responsive security bean 300. Operation in this fashion is discussed in more detail below with respect to FIG. 7. A combination of operations may be supported, for example, the ping message from the master device 400 may also serve at the timeout timer reset signal at the security bean 300. In this way, should a signal line be cut, the master device 400 can disable the remaining security beans 300 and the disconnected security bean 300 can set itself to disabled mode.

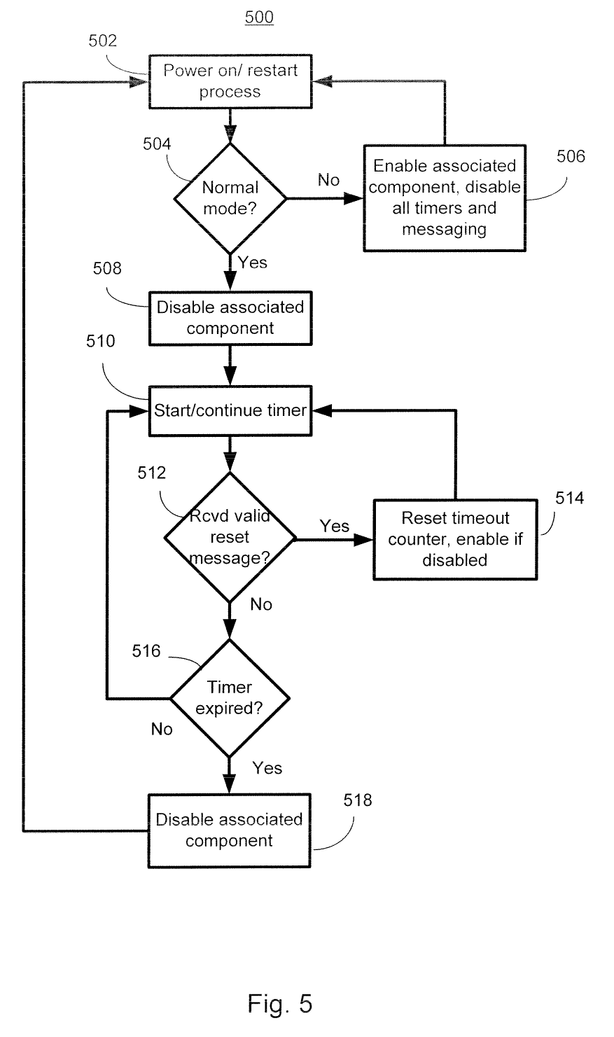

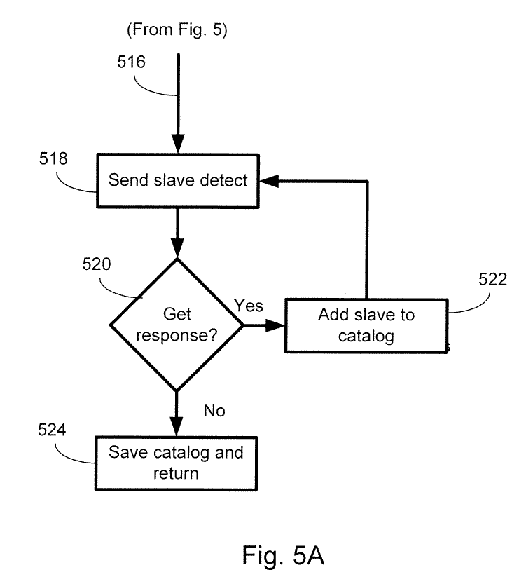

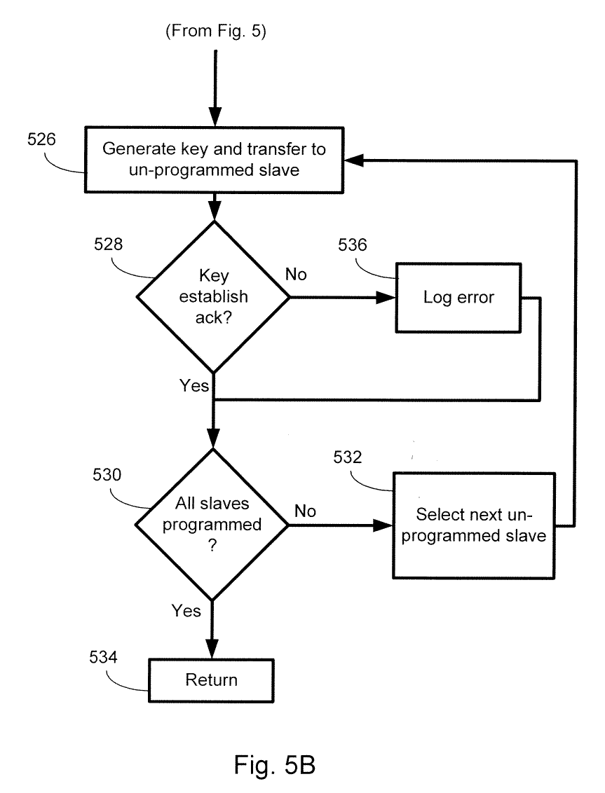

FIG. 5 is a flow chart illustrating a method 500 of installing and configuring master and slave security devices in an electronic device 200, such as computer 110. At block 502, a transport key may be injected into the master device 400, or a component thereof, for example, during a chip testing process at a manufacturing facility. This transport key may be used to verify a future installation-related command. At block 504, the master device 400 may be disposed in an electronic device 200. At block 506, a plurality of slave devices, such as slave device 300 may be disposed in the electronic device. To each slave device 300 may communicate with the master device 400 independently. That is, even if communications are carried over a common bus, the master device 400 may be able to identify source and destination when receiving and sending.

At block 508, a signal may be sent to the master device 400 indicating that the master device 400 should establish a binding between itself and all available slave devices 300. The signal may be authenticated using the transport key in the master device 400. This process may be initiated at the end of a manufacturing process for the electronic device 200 and may be performed while the electronic device 200 is in a secure environment. Before binding between the master device 400 and its associated slave devices 300, the electronic device 200 is vulnerable to attack. The master-slave binding process of block 508 may include generation of a master key for the master device 400. While public key cryptography may be used for the master-slave binding process and for authenticating communications between devices, symmetric key cryptography usually executes faster and can be less costly to implement. At block 510, a slave detect process may be initiated to determine what slave devices are available. Details of the slave detect process are shown in FIG. 5A.

Turning briefly to FIG. 5A, the entry point 516 from FIG. 5 may be taken to block 518, where the master device 400 may broadcast a slave detect message. At block 520, a response may be received from a slave device 300. Particularly when configured on a single bus, a number of collision avoidance mechanisms may be used to allow a response from a single device to be received. When a response is received at block 520, the “yes” branch from block 520 may be followed to block 522 and the responding slave device may be added to a catalog of slave devices. Slave devices may be identified by a serial number or factory installed globally unique identifier. Processing may continue at block 518 and the slave detect message rebroadcast. The loop adding slave devices to the catalog may be followed one time for each slave device 300 installed in the electronic device 200. In one embodiment, after he slave has been catalogued it will no longer respond to a slave detect message. When all slave devices have been discovered, the “no” branch from block 520 may be followed to block 524 or the catalog of slave devices may be saved and execution continued at block 510 of FIG. 5.

Returning to FIG. 5, when each slave device 300 has been catalogued at block 510, processing may continue at block 512 and a key establish process may be initiated. Details of the key establish process are illustrated in FIG. 5B.

Turning briefly to FIG. 5B, the key establish process may begin a block 526 where a device key may be generated for an individual slave device 300 and sent to the individual slave device 300 using a key establish message. The device key may be a random number or may be derived, for example, by encrypting a padded individual slave device serial number with the master key. At block 528, when the key establish command is acknowledged, the “yes” branch from block 28 may be followed to block 530. If more slave devices need programming, the “no” branch from block 530 may be followed to block 532 and the next un-programmed slave device may be selected in the loop continued at block 526. When all the slave devices have been programmed, the “yes” branch from block 530 may be followed to block 534, and in the routine exited. At block 528, if an acknowledgment of the key establish message is not received, the “no” branch from block 528 may be followed to block 536 and an error may be logged for that slave device 300. Managing acknowledgment errors may be implementation specific and may involve retrying the key establish message or may go back to the slave detect process to determine if an error occurred in that process.

Returning to FIG. 5, following block 512, the configuration process may end at block 514. In some embodiments, further steps may be performed, such as setting the default state of each security bean 300, or setting timer values related to timeout periods.

The exemplary steps described above illustrate a process of first cataloging all slave devices and then establishing keys for each device. Other embodiments may combine slave device discovery with key establishment so that both steps occur for each slave device before moving on to another slave device.

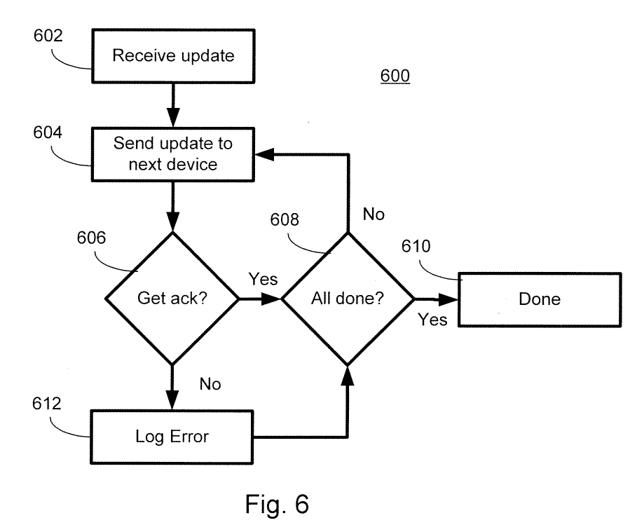

Once configured, the master device 400 and each of the slave devices 300 may support a protocol including a number of operational and maintenance messages. FIGS. 6-10 illustrate representative messages of this type, although the commands illustrated are neither required nor all-inclusive.

FIG. 6 illustrates a method 600 of performing a firmware update for a slave device 300. At block 602, the master device 400 may receive a firmware update, for example authenticated using either the transport key or a key subsequently installed and known to a trusted entity. At block 604 one of the installed slave devices may be selected and the firmware updates sent to it. At block 606, an acknowledgment may be received from the selected slave device and processing continued at block 608, following the “yes” branch from block 606. If additional slave devices remain, the no branch from block 608 may be taken to block 604 and another slave device selected. If, at block 606 an acknowledgment is not received, an error message may be logged at block 612 by following the no branch from block 606. After the error is logged, and any error related processing completed, execution may continue at block 608. When, at block 608, all the devices have been updated with the new firmware, the yes branch from block 608 may be taken to block 610 and the command completed and execution returned to the calling party.

FIG. 7 illustrates a method 700 of operating in the master and slave devices to detect hardware tampering in the electronic device 200. While not limited to the methods described, two different schemes for hardware tampering protection are used to illustrate. The first uses a simple ping and response scheme. The master device 400 sends a message to each slave device 300 and listens for a response. The message in response may each be either encrypted or cryptographically authenticated to help prevent spoofing. If the master device 400 receives enough responses in a designated time period, normal operation may continue. If, however, the master device 400 does not receive enough responses in a designated time period, the master device 400 may send a shutdown signal to each slave device 300, and as described above, causes the electronic device 200 to be rendered non-operational. The second scheme relies on timeout or watchdog timers in each slave device 300. If an authenticated message from the master device 400 is not received during the timeout period to reset the timeout timer, the slave device 300 will disable its associated component. If the two schemes are used in conjunction with each other the ping message in the timeout timer reset message may be combined.

At box 702, the master device 400 may exit a delay period and send a message to a selected slave device 300 at block 704. The message may be a ping message, that is a simple message to which a reply is expected. The message may also include a timer reset signal as part of the ping message, as described above. The ping message and any response may be encrypted using a derived key based on a random number in the unique slave device key. To accommodate this, the random number may be included in the ping message. At box 706, the master device 400 may receive a ping acknowledgment. If the ping acknowledgment is received within an acknowledgment timeframe and can be correctly authenticated, the “yes” branch from block 706 may be taken to block 708. If not all slave devices 300 have been sent a ping message, and no branch from block 708 may be followed to block 704 and another device selected and sent the ping message. If, at block 708, all the devices have been sent the ping message, the “yes” branch from block 708 may be followed to block 710.

At block 710, if the number of slave devices 300 that respond timely and correctly exceeds a threshold amount, for example 70%, the “yes” branch from block 710 may be followed to block 702 and a delay period entered for timing the next round of ping messages. In one embodiment, a range from one minute to five minutes may be used as the delay period. If however, the threshold level is not meant the “no” branch from block 710 may be followed to block 712 and a shutdown message sent to each slave device 300, or at least to each responsive slave device 300. If, at block 706 an acknowledgment is not received, the acknowledgment was not timely, or could not be authenticated, the “no” branch from block 706 may be followed to block 714 and an error may be logged. The log may be used later at block 710 to determine whether the threshold level of responses has been met.

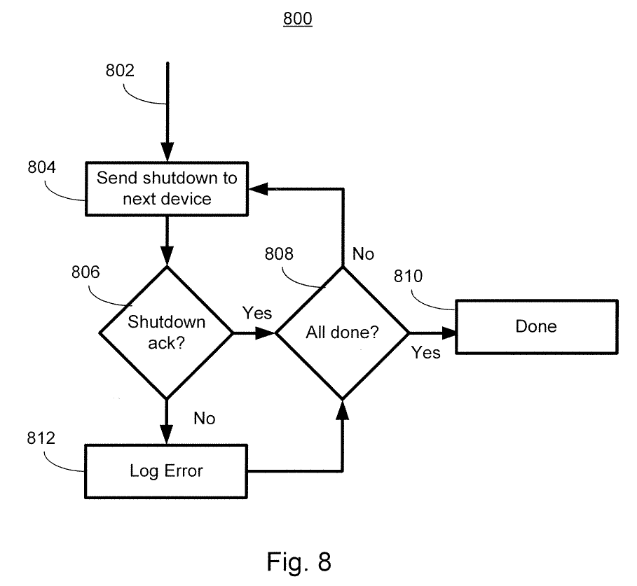

FIG. 8 illustrates a method 800 of sending a shutdown message from the master device 400 to each of the slave devices 300 in the electronic device 200. This process may be followed any time the electronic device 200 is to be disabled, for example, if a metered use balance falls below an acceptable limit for a predetermined amount of time, such as a month. This process may also be followed when a threshold number of devices do not respond to a ping message, such as that block 712 of FIG. 7. The shutdown message may cause each slave device 300 to disable its respective functional component of the electronic device 200.

Following the entry point 802, at block 804 a shutdown message may be sent to a slave device 300. At block 806, if an acknowledgment is received, the “yes” branch from block 806 may be followed to block 808. If additional devices need to receive the shutdown message, the “no” branch from block 808 may be followed to block 804 and another slave device selected and sent the shutdown message. If, at block 808 all the devices have received the shutdown message, the “yes” branch from block 808 may be followed to block 810 in the routine exited. If, at block 806 a shutdown acknowledgment is not received, the “no” branch from block 806 may be followed to block 812 or an error may be logged and additional error processing steps performed. Execution may continue at block 808 as described above.

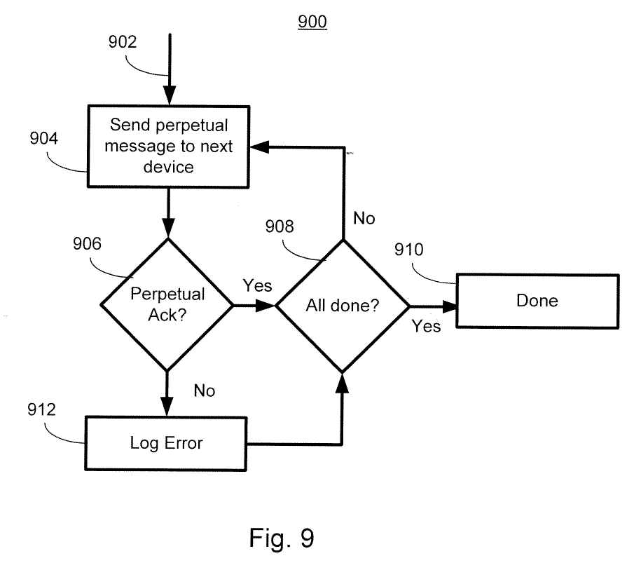

FIG. 9 illustrates a method 900 of sending a perpetual message from the master device 400 to each of the slave devices 300 in the electronic device 200. The perpetual message may instruct each slave device 300 to cease its security-related activities and to ignore future messages.

Following the entry point 902 to block 904, a perpetual message may be sent to each slave device 300, using either an encrypted or cryptographically authenticated message, for example, a MAC. When an acknowledgment of the perpetual messages is received at block 906 the “yes” branch may be taken to block 908. If more devices are to receive the perpetual message, the “no” branch from block 908 may be taken to block 904 and the message sent to a remaining slave device 300. If all the devices have been programmed, the “yes” branch from block 908 may be taken to block 910 in the routine exited. If at block 906, the perpetual message is not acknowledged, the “no” branch from block 906 may be taken to block 912, the error logged and execution continued at block 908, as described above.

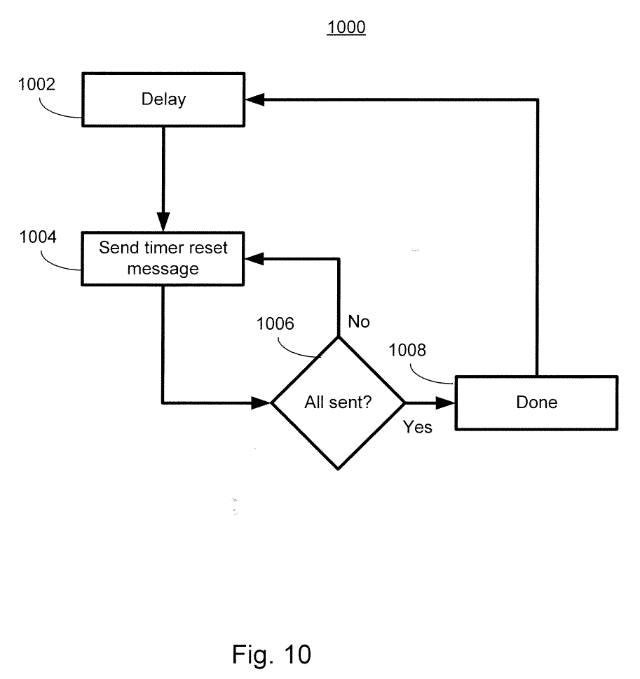

FIG. 10 illustrates a method 1000 of sending a timer reset message to each slave device 300 in the electronic device 200. Upon exiting a delay period at block 1002 a timer reset message may be sent at block 1004 to a selected slave device 300. If additional slave devices need to be contacted the “no” branch from block 1006 may be followed back to block 1004. If all devices have been contacted the “yes” branch from block 1006 may be followed to block 1008, the routine finished and the delay period 1002 reentered. As described above, the timer reset message may be used when the slave device acts independently of the master to disable its corresponding functional component in the absence of the timer reset message.

The protocol described above provides a functional set of tools for the management of a plurality of security devices used to monitor and detect tampering in an electronic device. The use of such a protocol may help create the secure environment required for an underwriter to take on financial risk of subsidizing an electronic device using a subscription-oriented payback mechanism. Ultimately, both the end-user in the underwriter benefit from the capabilities created by the use of the master-slave devices and their associated protocol.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of managing a master-slave relationship between security devices in an electronic device comprising:
disposing a master device in the electronic device;
disposing a plurality of slave devices, each of the slave devices in independent communication with the master device and each of the slave devices operable to disable a respective functional element of the electronic device;
sending a message from the master device to each of the slave devices at an interval;
determining when a reply message from each of the slave devices, responsive to the message, is timely and correct; and
sending a shutdown message that instructs each slave device to disable its respective functional element when a threshold of reply messages from the slave devices are one of untimely and incorrect.

2. The method of claim 1, further comprising acquiring a master key into the master device and communicating a symmetric key based on the master key, the symmetric key unique to each slave device.

3. The method of claim 2, wherein sending a message comprises sending a message from the master device to each of the slave devices at an interval, the message cryptographically authenticated with a key corresponding to the symmetric key unique to each slave device.

4. The method of claim 2, wherein determining when the reply message from each of the slave devices, responsive to the message, is timely and correct comprises determining when a reply message from each of the slave devices, responsive to the message, is timely when received during a reply message timing window and is correct when cryptographically authenticated.

5. The method of claim 1, wherein sending a message comprises sending a timer reset message to each slave device prior to a timeout period, thereby preventing in each slave device from disabling a respective component at the end of the timeout period.

6. The method of claim 1, further comprising issuing a slave detect message from the master device and receiving a slave detect response message from each slave device.

7. The method of claim 1, further comprising issuing a key establish message from the master device to each slave device individually, the key establish message including a derived device key based on a master key of the master device.

8. The method of claim 7, further comprising receiving at the master device a key establish acknowledgement message from each of the slave devices upon successful installation of the derived device key by each respective slave device.

9. The method of claim 7, wherein sending the message from the master device to each of the slave devices at an interval comprises sending a ping message from the master device to each respective slave device, each ping message cryptographically authenticated using a key corresponding to the derived device key of each respective slave device.

10. The method of claim 9, wherein determining when the reply message from each of the slave devices, responsive to the message, is timely and correct comprises determining when a ping response message from each of the slave devices is received during a timed response window and is cryptographically authenticated using the key corresponding to the derived device key.

11. The method of claim 1, further comprising receiving a shutdown message acknowledgement at the master device from each slave device, acknowledging receipt of the shutdown message.

12. The method of claim 1, further comprising sending a perpetual message from the master device to each slave device, instructing each slave device to permanently enable its respective functional element and to ignore further messages from the master device.

13. The method of claim 12, further comprising receiving a perpetual message acknowledgement at the master device from each slave device, acknowledging receipt of the perpetual message.

14. A computer-readable medium having computer-executable instructions for executing a method on a master device for securing an electronic device having at least one master device and a plurality of slave devices, the master device having a manufacturing transport key, the method comprising:
installing a master key responsive to a signal authenticated with the manufacturing transport key;
issuing a slave-detect message;
receiving a slave-detect response message from each of the plurality of slave devices;
developing a unique derived key for each of the plurality of slave devices;
installing the unique derived key in each of the plurality of slave devices using a separate key-establish message for each of the plurality of slave devices, the separate key establish message containing the respective unique derived key for each of the plurality of slave devices;
receiving a key-establish acknowledgement message from each of the plurality of slave devices; and
sending a message periodically to each of the plurality of slave devices, the message cryptographically authenticated and part of a protocol for detecting and sanctioning tampering in the electronic device.

15. The computer-readable medium of claim 14, wherein the method further comprises:
sending a ping message to each of plurality of slave devices;
receiving a ping message response from a set of the plurality of slave devices; and
sending a shutdown message to each of the plurality of slave devices when a number of ping response messages received from the set of the plurality of slave devices fails to reach a threshold level.

16. The computer-readable medium of claim 14, wherein the method further comprises issuing a firmware update message including a firmware update to each of the plurality of slave devices.

17. The computer-readable medium of claim 16, wherein the method further comprises receiving a firmware update acknowledgement message from each of the plurality of slave devices acknowledging successful installation of the firmware update.

18. The computer-readable medium of claim 14, wherein sending a message periodically to each of the plurality of slave devices comprises sending periodically one of a ping message that generates a ping response message and a timer reset message that causes a target slave device to reset its watchdog timer.

19. A computer-readable medium having computer-executable instructions for executing a method on a slave device for securing an electronic device having at least one master device and a plurality of slave devices, the method comprising:
receiving a key from the master device for use in authenticating communication with the master device;
receiving a periodic message from the master device for use in determining health of the system;
disabling a functional element of the electronic device after receiving an authenticated shutdown message from the master device.

20. The computer-readable medium of claim 19, wherein the method further comprises permanently enabling the functional element of the electronic device responsive to an authenticated perpetual message from the master device.
